(19) United States
(12) Patent Application Publication
(10) Pub. No.: US 2026/0008272 A1
(43) Pub. Date: Jan. 8, 2026

(54) INK-JET RECORDING APPARATUS RECOVERING INK EJECTED FROM LINE HEADS DURING FLUSHING

(71) Applicant: KYOCERA Document Solutions Inc., Osaka (JP)

(72) Inventors: Yuko YANO, Osaka (JP); Yuzuru YUASA, Osaka (JP)

(73) Assignee: KYOCERA Document Solutions Inc., Osaka (JP)

(21) Appl. No.: 19/242,937

(22) Filed: Jun. 18, 2025

(30) Foreign Application Priority Data
Jul. 2, 2024 (JP) 2024-106779

(51) Int. Cl. B41J 2/185; B41J 2/17; B41J 11/00

(52) U.S. Cl. CPC B41J 2/185; B41J 2/1707; B41J 11/007; B41J 11/0085; B41J 2002/1853

(57) ABSTRACT

An ink-jet recording apparatus includes a conveying belt, an ink recovery container, an airflow generating device, and a controller. The conveying belt conveys a recording paper sheet to which ink droplets ejected from the line head are to be applied and includes an opening allowing the ejected ink droplets to pass through. The ink recovery container is opposed to the line head with the conveying belt in between and receives and recovers the ink droplets having passed through the opening. The airflow generating device generates an airflow that moves the ink droplets in an interior of the ink recovery container. The controller determines an amount of ink droplets recovered by the ink recovery container. When the amount of ink droplets recovered by the ink recovery container reaches a predetermined threshold or more, the controller controls the airflow generating device to accelerate generation of the airflow by the airflow generating device.

### INCORPORATION BY REFERENCE

This application claims priority to Japanese Patent Application No. 2024-106779 filed on Jul. 2, 2024, the entire contents of which are incorporated by reference herein.

### BACKGROUND

The present disclosure relates to ink-jet recording apparatuses that eject ink from line heads to a recording paper sheet to form an image on the recording paper sheet, and particularly relates to a technique in recovering ink ejected from line heads during flushing.

In ink-jet recording apparatuses, ink ejection through the nozzles of the line heads may be disrupted by an increase in ink viscosity in the nozzles or other reasons. Therefore, flushing is performed by forcibly ejecting ink from the nozzles to avoid failure in ink ejection. In doing flushing, it is necessary to recover ink ejected from the line heads.

There is also proposed an ink-jet recording apparatus in which a recording head and an encoder are provided on a carriage movable in a widthwise direction of a recording paper sheet and the location of the carriage is determined based on the pattern on an encoder film read by the encoder on the carriage or other information. Furthermore, in this ink-jet recording apparatus, because ink mist is generated upon ejection of an ink droplet from the recording head, whether or not the encoder film becomes dirty with ink mist is determined based on the S/N of an output signal from an encoder sensor. When the encoder film becomes dirty, the number of rotations of a mist recovery fan for recovering ink mist is increased to increase the mist recovery efficiency. In this manner, the ink-jet recording apparatus reduces the influence of ink mist on recording results.

### SUMMARY

A technique improved over the aforementioned techniques is proposed as one aspect of the present disclosure.

An ink-jet recording apparatus according to an aspect of the present disclosure includes a conveying belt, an ink recovery container, an airflow generating device, and a controller. The conveying belt conveys a recording paper sheet to which ink droplets ejected from the line head are to be applied and includes an opening that allows the ejected ink droplets to pass through. The ink recovery container is opposed to the line head with the conveying belt in between and receives and recovers the ink droplets having passed through the opening. The airflow generating device generates an airflow for use in moving the ink droplets in an interior of the ink recovery container. The controller includes a processor and, upon execution of a control program by the processor, determines an amount of ink droplets recovered by the ink recovery container. When the amount of ink droplets recovered by the ink recovery container reaches a predetermined threshold or more, the controller controls the airflow generating device to allow the airflow generating device to accelerate generation of the airflow.

### BRIEF DESCRIPTION OF THE DRAWINGS

FIG. 1 is a cross-sectional view showing an ink-jet recording apparatus according to an embodiment of the present disclosure.

FIG. 2 is a side view schematically showing a conveying belt, line heads, suction devices, ink recovery containers, and so on in the ink-jet recording apparatus according to the embodiment.

FIG. 3 is a plan view schematically showing the conveying belt, the line heads, the suction devices, the ink recovery containers, and so on in the ink-jet recording apparatus according to the embodiment.

FIG. 4 is a perspective view showing the appearance of the ink recovery container.

FIG. 5 is a perspective view showing porous materials and sheet materials contained in the ink recovery container and forming a plurality of layers therein.

FIG. 6 is a block diagram showing an internal configuration of the ink-jet recording apparatus according to the embodiment.

FIG. 7 is a flowchart showing the control procedure for determining the amount of ink droplets recovered by the ink recovery container and, upon reach of the amount of recovered ink droplets to a threshold or more, increasing the rotational speed of a suction fan of the ink recovery container.

### DETAILED DESCRIPTION

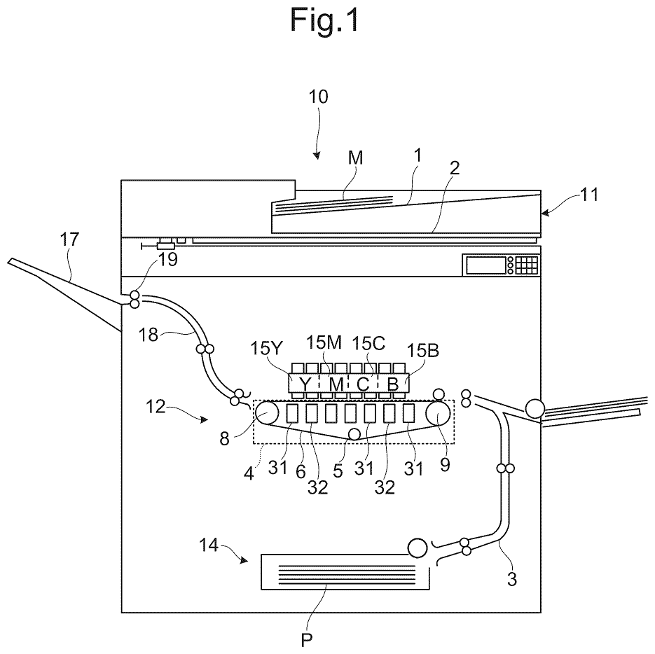

Hereinafter, a description will be given of an ink-jet recording apparatus according to an embodiment of the present disclosure. FIG. 1 is a cross-sectional view showing an ink-jet recording apparatus according to an embodiment of the present disclosure. As shown in FIG. 1, the ink-jet recording apparatus 10 includes an image reading device 11 and an image forming device 12.

The image reading device 11 includes as a pickup device for optically reading an image of an original document sheet M, for example, a contact image sensor (CIS). When a plurality of original document sheets M are placed on an original document tray 1, the image reading device 11 sequentially pulls out and conveys the plurality of original document sheets M sheet by sheet from the original document tray 1, reads an image of each original document sheet M with the pickup device while conveying the original document sheet M, and sequentially ejects the read original document sheets M to an ejection tray 2 to lay them one on top of another on the ejection tray 2. For each of the images of the original document sheets M, an output of the pickup device is converted to image data representing the image of the original document sheet M.

The image forming device 12 inputs the image data representing the image of each of the original document sheets M and forms the image of the original document sheet M represented by the image data on a recording paper sheet P using an ink-jet system. The image forming device 12 includes respective line heads 15B, 15C, 15M, and 15Y that eject ink droplets of four colors (black, cyan, magenta, and yellow). The line heads 15B, 15C, 15M, and 15Y eject ink droplets of the individual colors onto the recording paper sheet P being conveyed from a sheet feed device 14 via a conveyance path 3 to a conveyance unit 4 to allow the ink droplets to be applied to the recording paper sheet P, thus forming a multicolor image on the recording paper sheet P.

The conveyance unit 4 includes a drive roller 8, a driven roller 9, a tension roller 5, and a conveying belt 6. The conveying belt 6 is an endless belt and is mounted around the drive roller 8, the driven roller 9, and the tension roller 5. The drive roller 8 is a roller capable of being driven into counterclockwise rotation by a motor (for example, a stepping motor). When the drive roller 8 is driven into rotation, the conveying belt 6 travels around the above rollers counterclockwise and the driven roller 9 and the tension roller 5 rotate counterclockwise by following the travel of the conveying belt 6 engaged on them. The tension roller 5 is a roller that appropriately holds the tension of the conveying belt 6.

After the image forming device 12 forms the image of the original document sheet on the recording paper sheet P, the recording paper sheet P is conveyed along a conveyance path 18 and then ejected through a conveyance roller 19 to a sheet output tray 17.

Meanwhile, in a space formed between the drive roller 8 and the driven roller 9 located on either side of the conveying belt 6 and between the top and bottom of the loop of the belt, a plurality of suction devices 31 and a plurality of ink recovery containers 32 are arranged side by side. The suction devices 31 suck the air through a large number of air holes formed in the conveying belt 6 to allow the recording paper sheet P to be attracted to the conveying belt 6 by a negative pressure, thus keeping the recording paper sheet P flat.

The ink recovery containers 32 are opposed one to each of the line heads 15B, 15C, 15M, and 15Y with the conveying belt 6 in between. A plurality of openings are formed in the conveying belt 6. In a state where the openings in the conveying belt 6 have been moved to between the individual line head and the associated ink recovery container 32 by the traveling of the conveying belt 6 around the rollers, ink droplets ejected from the line head pass through the openings in the conveying belt 6 and are recovered by the ink recovery container 32 opposed to the line head.

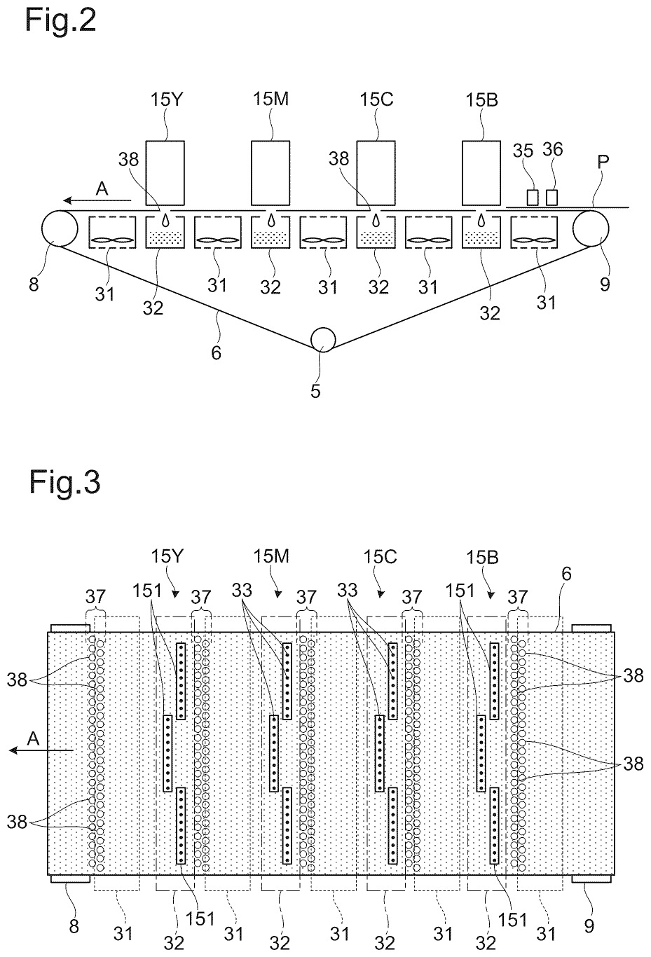

FIGS. 2 and 3 are a side view and a plan view respectively schematically showing the conveying belt 6, the line heads 15B, 15C, 15M, and 15Y, the suction devices 31, and the ink recovery containers 32. As shown in FIGS. 2 and 3, each of the line heads 15B, 15C, 15M, and 15Y is constituted by a combination of three head portions 151. The three head portions 151 are arranged, for example, along a widthwise direction of a recording paper sheet orthogonal to a direction A of conveyance of the recording paper sheet and arranged with each widthwise adjacent pair of head portions deviated in the direction A of conveyance, i.e., arranged in a staggered configuration.

Each head portion 151 includes a plurality of nozzles 33 through which ink is to be ejected, wherein the bottom ends of the nozzles 33 are positioned a predetermined distance (for example, 1 mm) apart from the upper surface of the conveying belt 6. The ejection of ink droplets through the nozzles 33 is done by a known piezoelectric system using piezoelectric elements or a known thermal system using a heater, in either of which ink droplets are ejected through the nozzles 33.

Black ink droplets are ejected through the nozzles 33 of the head portions 151 of the line head 15B to a recording paper sheet on the conveying belt 6, cyan ink droplets are ejected through the nozzles 33 of the head portions 151 of the line head 15C to the recording paper sheet on the conveying belt 6, magenta ink droplets are ejected through the nozzles 33 of the head portions 151 of the line head 15M to the recording paper sheet on the conveying belt 6, and yellow ink droplets are ejected through the nozzles 33 of the head portions 151 of the line head 15Y to the recording paper sheet on the conveying belt 6. Thus, four different colors of ink are applied to the recording paper sheet and, thus, a multicolor image is formed on the recording paper sheet.

As described previously, the conveying belt 6 has a large number of air holes formed to allow the air sucked by the suction devices 31 to pass through them. The recording paper sheet P on the conveying belt 6 is attracted to the conveying belt 6 by a negative pressure generated by the air suction through the air holes and thus kept flat.

Furthermore, the conveying belt 6 is provided with a plurality of flushing regions 37 extending in the widthwise direction of the recording paper sheet. In each of the flushing regions 37, a plurality of openings 38 are formed to allow ink droplets ejected from one of the line heads 15B, 15C, 15M, and 15Y to pass through them. When the conveying belt 6 travels around the rollers and, thus, the subject flushing region 37 moves to between the line head and the opposed ink recovery container 32, ink droplets are ejected from the line head, pass through the openings 38 in the flushing region 37 located just below the line head, and are then recovered by the ink recovery container 32 opposed to the line head.

Each of the flushing regions 37 is formed to have a larger width than each of the line heads 15B, 15C, 15M, and 15Y, so that all of ink droplets ejected from each of the line heads 15B, 15C, 15M, and 15Y can pass through the openings 38 in the flushing region 37 located just below the line head. Herein, the shape of each opening 38 is circular, but is not limited to a circular shape and may be elliptical or rectangular.

The ejection of ink droplets done for the recovery into the ink recovery containers 32 in the above manner is referred to as flushing. The reason for flushing is that because ink ejection through the nozzles of the line heads may be disrupted by an increase in ink viscosity in the nozzles or other reasons, the disruption can be avoided by forcibly ejecting ink droplets in the nozzles by flushing and recovering them in the ink recovery containers 32.

The ink recovery containers 32 are detachably provided because they are exchanged for new ink recovery containers when filled up with recovered ink.

As shown in FIG. 2, a belt sensor 35 and a sheet sensor 36 are provided above a location on the conveying belt 6 into which a conveyed recording paper sheet P comes. The belt sensor 35 is, for example, an optical sensor and detects a reference position mark (not shown) put on a portion of the conveying belt 6. The sheet sensor 36 is, for example, an optical sensor and detects the leading edge and trailing edge of a recording paper sheet P being conveyed by the conveying belt 6.

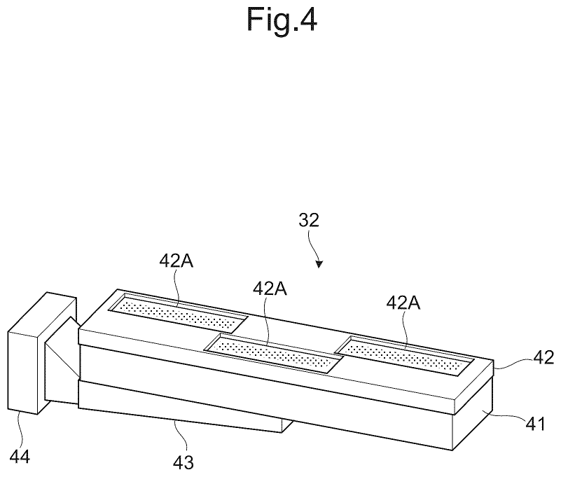

FIG. 4 is a perspective view showing the appearance of the ink recovery container 32. As shown in FIG. 4, the ink recovery container 32 includes: a body housing 41 in the shape of a rectangular parallelepiped; a lid 42 covering an upper opening of the body housing 41; a duct 43 provided over an opening in the bottom of the body housing 41; and a suction fan 44 provided at one end of the duct 43.

The lid 42 has three rectangular openings 42A formed therein. The ink recovery containers 32 are opposed one to each of the line heads 15B, 15C, 15M, and 15Y with the conveying belt 6 in between and the three head portions 151 of each line head are opposed one to each of the three rectangular openings 42A in the lid 42 of the opposed ink recovery container 32. Therefore, when the conveying belt 6 travels around the rollers and, thus, the subject flushing region 37 of the conveying belt 6 moves to between the line head and the opposed ink recovery container 32, at least one of the head portions 151 of the line head is opposed to the rectangular opening 42A of the lid 42 with the openings 38 of the flushing region 37 in between, and ink droplets ejected from the head portion 151 pass through the openings 38 of the flushing region 37, enter the rectangular opening 42A of the lid 42, and are then recovered by the ink recovery container 32.

A portion of the bottom of the body housing 41 is formed into an opening, the duct 43 is provided over the opening, and the other portion of the bottom of the body housing 41 is closed.

When the suction fan 44 provided at the one end of the duct 43 is rotated, the suction fan 44 sucks the air in the interior of the duct 43 and exhausts it to the outside. Thus, an airflow passing from the interior of the body housing 41 through the duct 43 to the suction fan 44 is generated and, concurrently, airflows passing through the rectangular openings 42A of the lid 42 to the interior of the body housing 41 are generated. Therefore, the air flows in a path from each rectangular opening 42A of the lid 42 via the interior of the body housing 41 and the duct 43 to the suction fan 44 and is then exhausted to the outside.

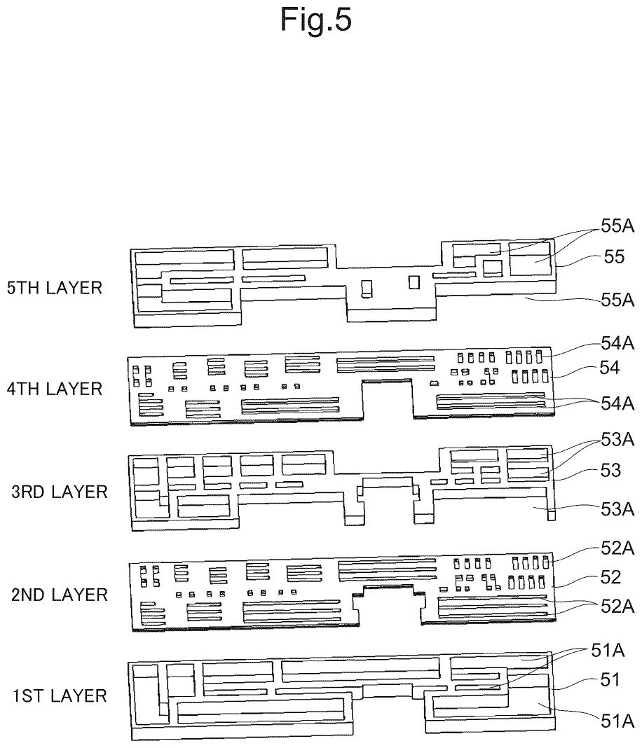

FIG. 5 is a perspective view showing the internal structure of the ink recovery container 32. As shown in FIG. 5, the body housing 41 of the ink recovery container 32 contains a porous material 51 as a first layer, a plate material 52 as a second layer, a porous material 53 as a third layer, a plate material 54 as a fourth layer, and a porous material 55 as a fifth layer overlaid in this order from bottom to top. The porous material 51 as the first layer, the porous material 53 as the third layer, and the porous material 55 as the fifth layer are open-cell foams capable of absorbing and retaining ink droplets and are made of a foam resin material, such as melamine sponge or urethane foam. Furthermore, the porous material 51 as the first layer, the porous material 53 as the third layer, and the porous material 55 as the fifth layer have air pathways 51A, 53A, and 55A, respectively, formed to guide the air to allow the air to pass therethrough.

The plate material 52 as the second layer and the plate material 54 as the fourth layer have air holes 52A and 54A, respectively, formed to guide the air to allow the air to pass therethrough. The air holes 52A of the plate material 52 as the second layer are superposed on the air pathways 51A of the porous material 51 as the first layer and the air pathways 53A of the porous material 53 as the third layer, while the air holes 54A of the plate material 54 as the fourth layer are superposed on the air pathways 53A of the porous material 53 as the third layer and the air pathways 55A of the porous material 55 as the fifth layer. Therefore, the air circulates from the air pathways 55A of the porous material 55 as the fifth layer through the air holes 52A of the plate material 52 as the second layer to the air pathways 53A of the porous material 53 as the third layer, and the air circulates from the air pathways 53A of the porous material 53 as the third layer through the air holes 54A of the plate material 54 as the fourth layer to the air pathways 55A of the porous material 55 as the fifth layer.

As described previously, when the suction fan 44 is rotated, the air flows in a path from each rectangular opening 42A of the lid 42 via the interior of the body housing 41 and the duct 43 to the suction fan 44 and is then exhausted to the outside. During the time, in the interior of the body housing 41, the air flows in a path from the air pathways 55A of the porous material 55 as the fifth layer via the air holes 54A of the plate material 54 as the fourth layer, the air pathways 53A of the porous material 53 as the third layer, and the air holes 52A of the plate material 52 as the second layer to the air pathways 51A of the porous material 51 as the first layer. Thus, the path of airflow in the interior of the body housing 41 becomes complicated, i.e., the air flows through each rectangular opening 42A of the lid 42 into the body housing 41, is stirred in the interior of the body housing 41, and then flows to the duct 43.

Therefore, when, as described previously, the subject flushing region 37 of the conveying belt 6 is moved to between the line head and the opposed ink recovery container 32 and ink droplets ejected from the head portions 151 of the line head pass through the openings 38 of the flushing region 37 and enter the rectangular openings 42A of the lid 42, the ink droplets move along with the flow of the air stirred in the interior of the body housing 41 and are brought into contact with and absorbed by the porous material 55 as the fifth layer, the porous material 53 as the third layer or the porous material 51 as the first layer or, alternatively, the ink droplets are atomized into a mist by the flow of the air stirred in the interior of the body housing 41 and brought into contact with and absorbed by either one of the porous materials 55, 53, and 51. In this manner, the ink droplets ejected from the line head are recovered in the ink recovery container 32.

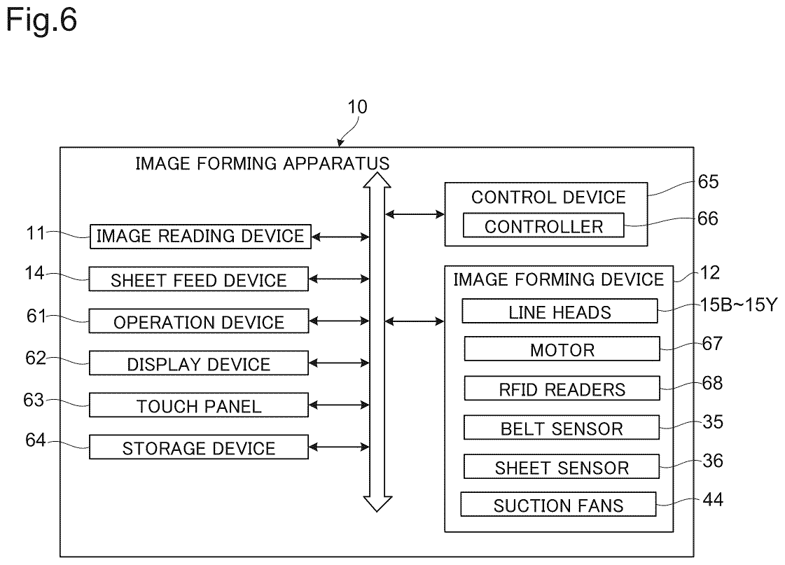

FIG. 6 is a block diagram showing an internal configuration of the ink-jet recording apparatus 1. As shown in FIG. 6, the ink-jet recording apparatus 10 includes the image reading device 11, the image forming device 12, the sheet feed device 14, an operation device 61, a display device 62, a touch panel 63, a storage device 64, and a control device 65. These components can transmit and receive data or signals to and from each other via a bus.

The image forming device 12 is provided with: the line heads 15B, 15C, 15M, and 15Y; a motor (for example, a stepping motor) 67 that rotates the drive roller 8 for the conveying belt 6; the belt sensor 35 that detects a reference position mark (not shown) put on a portion of the conveying belt 6; the sheet sensor 36 that detects the leading edge and trailing edge of a recording paper sheet P on the conveying belt 6; the suction fans 44 for the ink recovery containers 32; and so on.

The operation device 61 includes physical keys, including numeric keys, an Enter key, and a Start key. The display device 62 is formed of a liquid crystal display (LCD), an organic EL (organic light-emitting diode (OLED)) display or the like.

The touch panel 63 is disposed over the screen of the display device 62. The touch panel 63 is a touch panel of a resistive film system, a capacitance system or any other system, detects a touch on the touch panel 63 with a user's finger or the like, together with a point of the touch, and outputs a detection signal indicating the coordinate of the point of touch to a controller 66 of the control device 65.

The storage device 64 is a large-capacity storage device, such as an SSD (solid state drive) or an HDD (hard disk drive), and holds various types of application programs and various types of data.

RFID readers 68 are provided one at each of sites where the ink recovery containers 32 are attached, and read the respective amounts of ink recovered in the ink recovery containers 32 by flushing from respective RFID tags (not shown) on the ink recovery containers 32. An RFID tag is provided on each of the ink containers that contains ink to be supplied to each of the line heads 15B, 15C, 15M, and 15Y. Each RFID tag stores the respective amount K of ink recovered by the corresponding ink recovery containers 32 during flushing.

The control device 65 is made up of a processor, a RAM (random access memory), a ROM (read only memory), and so on. The processor is, for example, a CPU (central processing unit), an ASIC (application specific integrated circuit) or an MPU (micro processing unit). When the control program stored in the above ROM or the storage device 64 is executed by the above processor, the control device 65 functions as a controller 66.

The controller 66 preforms overall control of the ink-jet recording apparatus 10. The controller 66 is connected to the image reading device 11, the image forming device 12, the sheet feed device 14, the operation device 61, the display device 62, the touch panel 63, the storage device 64, and so on and performs operation control on each of these components and signal or data transfer to and from each of the components.

The controller 66 serves as a processor that executes various types of processing necessary for image formation by the ink-jet recording apparatus 10. Furthermore, the controller 66 accepts an operation instruction input by a user, based on a detection signal output from the touch panel 63 or a user's operation on the physical keys of the operation device 61. For example, the controller 66 accepts through the touch panel 63 a user's touch gesture on a GUI (graphical user interface) or the like being displayed on the screen of the display device 62. The controller 66 also has the function of controlling the display operation of the display device 62.

The line heads 15B, 15C, 15M, and 15Y correspond to the line head defined in CLAIMS, the conveying belt 6 corresponds to the conveying belt defined in CLAIMS, the ink recovery containers 32 correspond to the ink recovery container defined in CLAIMS, the suction fans 44 of the ink recovery containers 32 correspond to the airflow generating device defined in CLAIMS, and the controller 66 corresponds to the controller defined in CLAIMS.

In the ink-jet recording apparatus 10 having the above structure, the controller 66 controls the drive of the motor 67 for use in rotating the drive roller 8 for the conveying belt 6 to allow the conveying belt 6 to convey a recording paper sheet P, concurrently controls the line heads 15B, 15C, 15M, and 15Y to allow the line heads 15B, 15C, 15M, and 15Y to eject ink droplets to the recording paper sheet P on the conveying belt 6 and thus form a multicolor image on the recording paper sheet P, and furthermore allows ink droplets ejected from the line heads 15B, 15C, 15M, and 15Y to pass through the openings 38 in the flushing regions 37 to allow the ink recovery containers 38 to recover the ink droplets.

In forming a multicolor image on a recording paper sheet P, the ejection of ink droplets from each of the line heads 15B, 15C, 15M, and 15Y is started with respective timings when the leading edge of the recording paper sheet P reaches each of the line heads 15B, 15C, 15M, and 15Y.

For example, the respective distances from the location where the leading edge of the recording paper sheet P has been detected by the sheet sensor 36 to each of the line heads 15B, 15C, 15M, and 15Y are known and the length of conveyance of the recording paper sheet P is correlated with the angle of rotation of the motor 67 that rotates the drive roller 8 for the conveying belt 6. Therefore, the angle of rotation (amount of rotation) of the motor 67 required to convey the recording paper sheet P each of the above distances from the location where the leading edge of the recording paper sheet P has been detected can be determined.

When the controller 66 controls the motor 67 for use in rotating the drive roller 8 for the conveying belt 6 to allow the conveying belt 6 to convey a recording paper sheet P and the leading edge of the conveyed recording paper sheet P is detected by the sheet sensor 36, the controller 66 determines the angle of rotation of the motor 67 from the time of detection of the leading edge. The controller 66 sequentially determines the respective timings when the determined angle of rotation (amount of rotation) of the motor 67 has reached the respective angles of rotation corresponding to the respective distances, i.e., determines the respective timings when the leading edge of the recording paper sheet P has reached each of the line heads 15B, 15C, 15M, and 15Y, and allows the respective line heads 15B, 15C, 15M, and 15Y to start ejecting ink droplets with the respective timings. Thus, four different colors of ink droplets are ejected and applied to the recording paper sheet P and, thus, a multicolor image is formed on the recording paper sheet P.

In allowing ink droplets ejected from each of the line heads 15B, 15C, 15M, and 15Y to pass through the openings 38 in the flushing regions 37 of the conveying belt 6 and allowing each of the ink recovery containers 32 to recover the ink droplets, the controller 66 determines the respective locations of the flushing regions 37 relative to the location of the recording paper sheet P on the conveying belt 6 and selects the flushing region 37 not located under the recording paper sheet P based on the above respective timings. Then, at the time when the selected flushing region 37 moves and reaches between the line head and the ink recovery container 32, the controller 66 allows the line head to eject ink droplets.

For example, since the respective positions of the flushing regions 37 of the conveying belt 6 relative to the reference position mark on the conveying belt 6 are known, when the belt sensor 35 detects the reference position mark on the conveying belt 6, the controller 66 can determine the respective locations of the flushing regions 37 relative to the location where the reference position mark has been detected. When the conveying belt 6 is allowed to further travel around the rollers and the reference position mark moves from the location where the reference position mark has been detected, the controller 66 detects, based on the angle of rotation of the motor 67 for use in rotating the drive roller 8 for the conveying belt 6, the location where the reference position mark has moved from the location where the reference position mark has been detected, and the respective locations where the flushing regions 37 have moved relative to the location where the reference position mark has been detected. Furthermore, since the respective distances from the location where the reference position mark has been detected to each of the line heads 15B, 15C, 15M, and 15Y are known, the controller 66 can determine, based on the respective locations where the flushing regions 37 have moved relative to the location where the reference position mark has been detected and the respective distances from the reference position mark to each of the flushing regions 37, the relative locations between each of the flushing regions 37 and each of the line heads 15B, 15C, 15M, and 15Y. Therefore, for each of the flushing regions 37 of the conveying belt 6, the respective timings when the flushing region 37 has moved and reached between each of the line heads 15B, 15C, 15M, and 15Y and the associated ink recovery container 32 can be detected. Moreover, since the distance between the location where the reference position mark has been detected and the sheet sensor 36 is known, the controller 66 can determine, based on this distance and two locations of the reference position mark when each of the leading edge and trailing edge of the recording paper sheet P has been detected by the sheet sensor 36, the location of the recording paper sheet P (i.e., the respective locations of the leading edge and trailing edge thereof) relative to the reference position mark on the conveying belt 6. Furthermore, since the respective positions of the flushing regions 37 relative to the reference position mark are known, the controller 66 can also determine the respective locations of the flushing regions 37 relative to the location of the recording paper sheet P on the conveying belt 6 and thus can also detect the flushing region 37 of the conveying belt 6 not located under the recording paper sheet P. Therefore, the controller 66 can detect the respective timings when the flushing region 37 of the conveying belt 6 not located under the recording paper sheet P has moved and reached between each of the line heads 15B, 15C, 15M, and 15Y and the associated ink recovery container 32 by travel of the conveying belt 6 around the rollers.

The controller 66 controls the motor 67 for use in rotating the drive roller 8 for the conveying belt 6, determines the location of the reference position mark of the conveying belt 6 and the respective locations of the flushing regions 37 at the time when the reference position mark on the conveying belt 6 has been detected by the belt sensor 35, constantly determines, according to the angle of rotation of the motor 67, the location where the reference position mark on the conveying belt 6 has moved and the respective locations where the flushing regions 37 have moved, and updates them. When determining the respective locations where the flushing regions 37 have moved, the controller 66 determines the relative locations between each of the flushing regions 37 and each of the line heads 15B, 15C, 15M, and 15Y, and determines, for each of the flushing regions 37, the respective timings when the flushing region 37 has moved and reached between each of the line heads 15B, 15C, 15M, and 15Y and the associated ink recovery container 32.

Furthermore, when the leading edge and trailing edge of the recording paper sheet P being conveyed by the conveying belt 6 have been detected by the sheet sensor 36, the controller 66 determines the location of the recording paper sheet P on the conveying belt 6 relative to the reference position mark, determines the respective locations of the flushing regions 37 relative to the location of the recording paper sheet P on the conveying belt 6, and selects the flushing region 37 of the conveying belt 6 not located under the recording paper sheet P.

Then, with the respective timings when the selected flushing region 37 has moved and reached between each of the line heads 15B, 15C, 15M, and 15Y and the associated ink recovery container 32, the controller 66 allows ink droplets to be ejected from the line head to which the selected flushing region 37 has reached. The ink droplets pass through the openings 38 in the selected flushing region 37 of the conveying belt 6 and are then recovered in the ink recovery container 32 opposed to the line head.

In ejecting ink droplets for flushing from the line head and recovering the ink droplets into the ink recovery container 32 in the above manner, when the amount of ink droplets recovered in the ink recovery container 32 becomes large, the recovery efficiency may decrease. For example, it is possible that the porous material 51 as the first layer, the porous material 53 as the third layer, and the porous material 55 as the fifth layer in the ink recovery container 32 expand due to absorption of ink and, thus, their air pathways 51A, 53A, and 55A are narrowed. Alternatively, it is possible that the air holes 52A of the plate material 52 as the second layer and the air holes 54A of the plate material 54 as the fourth layer are narrowed by adhesion of ink thereto. For these reasons, the flow amount or flow rate of the air in the interior of the body housing 41 of the ink recovery container 32 may decrease and, thus, the ink recovery efficiency of the ink recovery container 32 may decrease.

To cope with this, in this embodiment, the controller 66 determines, for each of the ink recovery containers 32 one opposed to each of the line heads 15B, 15C, 15M, and 15Y, the amount of ink droplets recovered by the ink recovery container 32, and increases the rotational speed of the suction fan 44 of the ink recovery container 32 when the amount of ink droplets recovered by the ink recovery container 32 reaches a predetermined threshold (for example, 50% of the amount limit of ink droplets to be recovered by the ink recovery container 32) or more. Thus, the decrease in flow amount or flow rate of the air in the interior of the body housing 41 of the ink recovery container 32 can be avoided and, thus, the decrease in ink recovery efficiency of the ink recovery container 32 can be prevented.

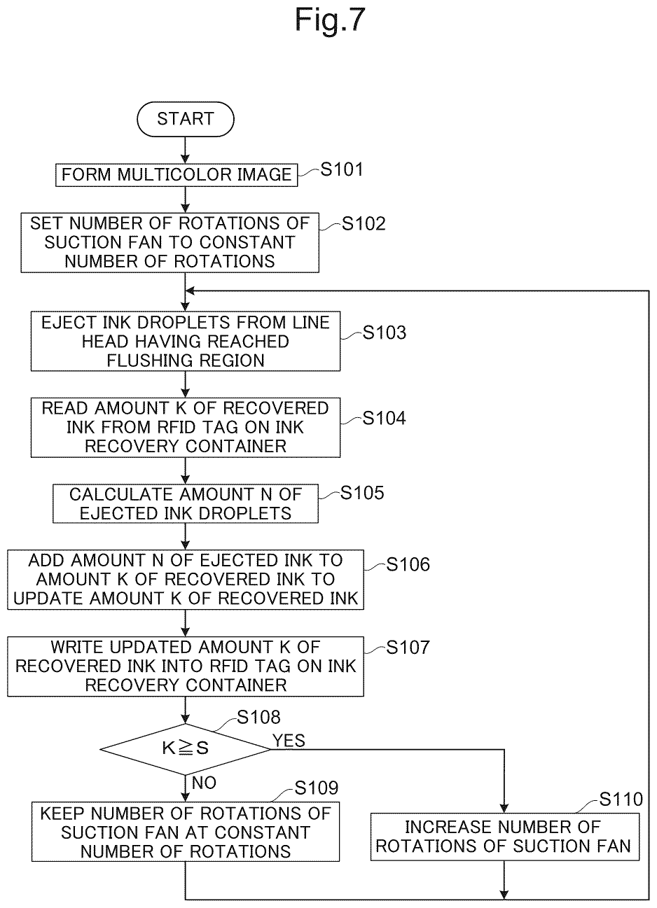

Next, a description will be given of the control procedure for determining the amount of ink droplets recovered by the ink recovery container 32 and, upon reach of the amount of recovered ink droplets to a threshold or more, increasing the rotational speed of the suction fan 44 of the ink recovery container 32, with reference to the flowchart shown in FIG. 7.

In the image forming operation, as described previously, the controller 66 controls the drive of the motor 67 for use in travelling the conveying belt 6 around the rollers to allow the conveying belt 6 to convey a recording paper sheet P and concurrently allows the line heads 15B, 15C, 15M, and 15Y to eject ink droplets to the recording paper sheet P on the conveying belt 6 and thus form a multicolor image on the recording paper sheet P (S101).

In doing so, the controller 66 sets the numbers of rotations of the suction fans 44 of the ink recovery containers 32 to a predetermined constant number of rotations (S102).

While allowing the motor 67 to travel the conveying belt 6 around the roller to perform the image formation, as described previously, the controller 66 constantly determines the location where the reference position mark on the conveying belt 6 has moved and the respective locations where the flushing regions 37 have moved and determines, for each of the flushing regions 37, the respective timings when the flushing region 37 has moved and reached between each of the line heads 15B, 15C, 15M, and 15Y and the associated ink recovery container 32. The controller 66 determines the respective locations of the flushing regions 37 relative to the location of the recording paper sheet Pon the conveying belt 6 and selects, based on these relative locations, the flushing region 37 of the conveying belt 6 not located under the recording paper sheet P. Then, with the respective timings when the selected flushing region 37 has moved and reached between each of the line heads 15B, 15C, 15M, and 15Y and the associated ink recovery container 32, the controller 66 performs flushing by allowing ink droplets to be ejected from the line head to which the selected flushing region 37 has reached (S103). In this manner, the flushing of each of the line heads 15B, 15C, 15M, and 15Y is performed. In doing so, since the suction fans 44 are driven at the constant number of rotations described above, the ink droplets are recovered in the ink recovery containers 32 by the suction fans 44.

In this state, for each of the ink recovery containers 32, the controller 66 allows the RFID reader 68 to read the amount K of ink recovered in the ink recovery container 32 from the RFID tag on the ink recovery container 32 (S104). Furthermore, for each of the line heads 15B, 15C, 15M, and 15Y, the controller 66 calculates the amount N of ink droplets ejected from the line head through the openings 38 in the flushing region 37 toward the ink recovery container 32 (S105), adds the amount N of ejected ink droplets to the amount K of ink recovered in the ink recovery container 32, and updates the amount K of ink recovered in this ink recovery container 32 to the amount K of recovered ink obtained by the addition (S106).

For example, in the case where a constant amount of ink droplets is ejected from the line head in a single flushing, the controller 66 assumes the amount K of ink recovered in the ink recovery container 32 to be correlated with the number of flushings, calculates, for each of the line heads 15B, 15C, 15M, and 15Y, the number of flushings, “1”, executed between the line head and the opposed ink recovery container 32 as an amount N of ejected ink droplets, adds the amount N (=1) of ejected ink droplets to the amount K of ink thus far recovered in the ink recovery container 32, and updates the previous amount K of ink recovered in this ink recovery container 32 to the amount K of recovered ink obtained by the addition.

In another case where the number of ejections or the ejection time of ink droplets ejected from the line head in a single flushing is calculated, the controller 66 assumes the amount K of ink recovered in the ink recovery container 32 to be correlated with the number of ejections or the ejection time of ink droplets, calculates, for each of the line heads 15B, 15C, 15M, and 15Y, the number of ejections or the ejection time of ink droplets ejected from the line head toward the ink recovery container 32 as an amount N of ejected ink droplets, adds the amount N of ejected ink droplets to the amount K of ink thus far recovered in the ink recovery container 32, and updates the previous amount K of ink recovered in this ink recovery container 32 to the amount K of recovered ink obtained by the addition.

For each of the ink recovery containers 32, the controller 66 allows the RFID reader 68 to write the amount K of recovered ink updated in S106 into the RFID tag on the ink recovery container 32 (S107) and determines whether or not the amount K of recovered ink updated in S106 is the predetermined threshold S or more (S108). For example, in the case where the amount K of ink recovered in the ink recovery container 32 is assumed to be correlated with the number of flushings, the threshold S is previously set to “50” and the controller 66 determines whether or not the amount K of recovered ink updated in S106 is the threshold S (=50) or more.

When the amount K of recovered ink is less than the threshold S (“NO” in S108), the controller 66 keeps the number of rotations of the suction fan 44 of the ink recovery container 32 where this amount K of ink has been recovered at the constant number of rotations set in S102 (S109) and goes back to the processing in $103.

On the other hand, when the amount K of recovered ink is not less than the threshold S (“YES” in S108), the controller 66 increases the number of rotations of the suction fan 44 of the ink recovery container 32 where this amount K of ink has been recovered from the constant number of rotations set in S102 to a predetermined number of rotations (for example, a number of rotations 10 to 30% larger than a standard number of rotations during normal operation) (S110) and goes back to the processing in S103. For example, in the case where the controller 66 controls the motor for the suction fan 44 by PWM, it increases the duty ratio of the pulse signal to be applied to the motor, thus increasing the number of rotations of the suction fan 44.

When, in this case, the amount K of recovered ink updated in S106 is not less than the threshold S, the controller 66 may calculate the difference between the amount K of recovered ink and the threshold S and increase the number of rotations of the suction fan 44 as the difference increases. For example, in the case where the controller 66 assumes the amount K of ink recovered in the ink recovery container 32 to be correlated with the number of flushings and set the threshold S to “50”, as the difference between the amount K of recovered ink and the threshold S (=50) increases, like “51”, “52”, . . . , the controller 66 increases the number of rotations of the suction fan 44.

After this, likewise, with the respective timings when each flushing region 37 of the conveying belt 6 selected as one not located under the recording paper sheet P has moved and reached between each of the line heads 15B, 15C, 15M, and 15Y and the associated ink recovery container 32, the controller 66 allows ink droplets to be ejected from the line head to which the selected flushing region 37 has reached, and, for each of the ink recovery containers 32, allows the RFID reader 68 to read the amount K of ink recovered in the ink recovery container 32 from the RFID tag on the ink recovery container 32. Furthermore, for each of the line heads 15B, 15C, 15M, and 15Y, the controller 66 calculates the amount N of ink droplets ejected from the line head through the openings 38 in the flushing region 37 toward the ink recovery container 32, adds the amount N of ejected ink droplets to the amount K of ink thus far recovered in the ink recovery container 32, and updates the previous amount K of ink recovered in this ink recovery container 32 to the amount K of recovered ink obtained by the addition. Moreover, when the amount K of recovered ink is less than the threshold S, the controller 66 keeps the number of rotations of the suction fan 44 of the ink recovery container 32 at the constant number of rotations. When the amount K of recovered ink is not less than the threshold S, the controller 66 sets the number of rotations of the suction fan 44 of the ink recovery container 32 to a number of rotations larger than the constant number of rotations.

As a result, the decrease in flow amount or flow rate of the air in the interior of the body housing 41 of the ink recovery container 32 can be avoided and, thus, the ink recovery efficiency of the ink recovery container 32 can be maintained.

As thus far described, in this embodiment, for each of the ink recovery containers 32, the amount K of ink recovered in the ink recovery container 32 is determined and, upon reach of the amount K of recovered ink to the threshold S or more, the rotational speed of the suction fan 44 of the ink recovery container 32 is increased. Therefore, the decrease in flow amount or flow rate of the air in the interior of the body housing 41 of the ink recovery container 32 can be avoided and, thus, the decrease in ink recovery efficiency of the ink recovery container 32 can be prevented. In addition, it is not particularly necessary to clean or exchange the ink recovery containers 32 or like components.

In the above embodiment, when the amount K of recovered ink updated in S106 is not less than the threshold S, the controller 66 increases the number of rotations of the suction fan 44. In addition to this, when the amount K of recovered ink updated in S106 reaches a limit value (extremely larger than the threshold S) which is a limit amount of ink to be recovered by the ink recovery container 32, the controller 66 may allow the display device 62 to display a message prompting to exchange this ink recovery container 32 for a new one. Seeing the message, the user removes the ink recovery container 32 in which the amount of recovered ink has reached the limit value, and attaches a new ink recovery container 32 instead.

Although in the above embodiment ejection of ink droplets for flushing is done while a multicolor image is formed on a recording paper sheet P, the controller 66 may allow ink droplets to be ejected for flushing before or after the formation of a multicolor image, i.e., when any multicolor image is not formed on a recording paper sheet P. In this case, there is no need to determine the respective locations of the flushing regions 37 relative to the location of the recording paper sheet P on the conveying belt 6 and select the flushing region 37 of the conveying belt 6 not located under the recording paper sheet P. Therefore, the controller 66 has only to determine, for each of the flushing regions 37, the respective timings when the flushing region 37 has moved and reached between each of the line heads 15B, 15C, 15M, and 15Y and the associated ink recovery container 32 and allow ink droplets to be ejected, with each of the timings, from the line head to which the selected flushing region 37 has reached.

In recovering ink ejected from the line head on flushing, it is desirable that even if the amount of recovered ink increases, the ink recovery efficiency is maintained. However, in the ink-jet recording apparatus described in BACKGROUND, ink mist is recovered, but ink ejected from the line head on flushing is not recovered. In addition, since dirt of the encoder film with ink mist is determined, this involves maintenance, such as cleaning and exchange of the encoder film.

Unlike this, in the above embodiment, ink ejected from the line head on flushing is recovered, there is no need for cleaning or exchange of the ink recovery container even when the amount of recovered ink increases, and the ink recovery efficiency can be maintained.

The structures, configurations, and processing of the embodiment described with reference to FIGS. 1 to 7 are merely illustrative and are not intended to limit the present disclosure to them.

While the present disclosure has been described in detail with reference to the embodiments thereof, it would be apparent to those skilled in the art that the various changes and modifications may be made therein within the scope defined by the appended claims.

What is claimed is:

1. An ink-jet recording apparatus comprising:
a line head that ejects ink droplets;
a conveying belt that conveys a recording paper sheet to which ink droplets ejected from the line head are to be applied and are formed an opening that allows the ejected ink droplets to pass through;
an ink recovery container that is opposed to the line head with the conveying belt in between and receives and recovers the ink droplets having passed through the opening;
an airflow generating device that generates an airflow for use in moving the ink droplets in an interior of the ink recovery container; and
a controller that includes a processor and, upon execution of a control program by the processor, determines an amount of ink droplets recovered by the ink recovery container, wherein when the amount of ink droplets recovered by the ink recovery container reaches a predetermined threshold or more, the controller controls the airflow generating device to allow the airflow generating device to accelerate generation of the airflow.

2. The ink-jet recording apparatus according to claim 1, wherein
the airflow generating device comprises a fan that generates the airflow in the interior of the ink recovery container, and
when the amount of ink droplets recovered by the ink recovery container reaches the threshold or more, the controller controls the fan to increase a number of rotations of the fan.

3. The ink-jet recording apparatus according to claim 2, wherein
the ink recovery container is provided internally with a porous material capable absorbing the ink droplets, and
a pathway of the airflow generated in the interior of the ink recovery container is formed in the interior of the ink recovery container by the porous material.

4. The ink-jet recording apparatus according to claim 1,
further comprising a display device,
wherein when the amount of ink droplets recovered by the ink recovery container reaches or exceeds a limit value larger than the threshold and predetermined as a limit amount of ink to be recovered by the ink recovery container, the controller allows the display device to display a message prompting to exchange the ink recovery container for a new ink recovery container.

5. The ink-jet recording apparatus according to claim 1,
further comprising a drive device that moves the conveying belt,
wherein the controller controls the drive device to move the conveying belt until the opening moves between the line head and the ink recovery container, and controls the line head to allow the ink droplets to be ejected from the line head toward the opening, and
the controller determines an amount of the ejected ink droplets and calculates the determined amount of ejected ink droplets as the amount of ink droplets recovered by the ink recovery container.
